(19) United States
(12) Patent Application Publication
(10) Pub. No.: US 2016/0090839 A1
(43) Pub. Date: Mar. 31, 2016

(54) METHOD OF PROTECTING THE HEALTH AND WELL-BEING OF COAL MINE MACHINE OPERATORS

(71) Applicant: Larry G. Stolarczyk, Raton, NM (US)

(72) Inventor: Larry G. Stolarczyk, Raton, NM (US)

(21) Appl. No.: 14/963,246

(22) Filed: Dec. 9, 2015

Related U.S. Application Data
(63) Continuation-in-part of application No. 14/555,519, filed on Nov. 26, 2014.
(60) Provisional application No. 62/258,977, filed on Nov. 23, 2015.
(60) Provisional application No. 62/202,156, filed on Aug. 6, 2015.
(60) Provisional application No. 62/214,981, filed on Sep. 6, 2015.

(51) Int. Cl. E21C 35/24; E21F 11/00; G06F 3/0338; G06T 13/80; G06F 3/01; E21C 35/08; G06T 19/00

(52) U.S. Cl. CPC E21C 35/24; E21C 35/08; E21F 11/00; G06T 19/006; G06T 13/80; G06F 3/011; G06F 3/0338

(57) ABSTRACT

A method of operating coal mine machinery that protects and maintains machine operators' health and well-being removes the machine operators to a clean, low-noise environment inside a refuge chamber. Inside, are controls, cameras, audio, and informational displays needed to run continuous mining machines nearby and communicate mine-wide with other personnel. Cameras fitted to the mining machines provide straight-ahead views, ground penetrating radars fitted to the cutting drums measure the coal depths in the ceilings above, the floors below, and the coal face ahead. Guidance data is presented on informational displays, and the data from the ceilings and floors is used to drive computer graphics special effects to graphically represent the coal ceilings and coal floors overlaying boundary rock. Audio pickups on the mining machine allow the operator to hear and feel how the machine is functioning, just as operators have always employed their other senses.

### BACKGROUND

1. Field of the Invention

The present invention relates to underground coal mining machinery, and more specifically methods for operating coal mine machinery that protect and maintain machine operators' health and well-being.

2. Description of the Problems to be Solved

Coal mining, by its very nature, has always been dangerous and hazardous to coal miners. The heavy equipment used is very noisy, dangerous even when operated correctly, and produces obnoxious and toxic fumes. The coal itself contains toxic elements like heavy metals and Sulphur, and the float coal dust created when the cutting drums break it free from the natural deposits has long been known to cause serious lung diseases and death. So, the Federal Government tries to limit all these hazards by passing laws to control the production and operation of machinery, and Laws to limit the workplace exposures of miners to float coal dust and noise.

We can do better, passing Laws hasn't worked well enough. We are now at a point in technology development in the world where we can bring real protections and workplace comfort to coal miners that will help them live long productive lives and help coal mining companies improve operational efficiencies and profits.

Real environments engage people in real, emotional ways. But in coal mining real environments can be hazardous and even deadly. So it would be beneficial in a number of ways to remove coal mining machine operators into a safer, mixed reality (MR) environment where they can be better protected. Augmented reality (AR) is one step toward virtual from real, and augmented virtuality (AV) is two steps. Essentially, if human senses find it difficult to distinguish between reality and virtuality, people become completely “immersed”.

Immersive Video (IV) technology can be projected as multiple images on scalable large screens, such as an immersive dome, and can be streamed so that viewers can look all around as if they were really there. Different IV technologies all have a common denominator, being able to navigate within the video, and explore in all directions. For example, Immersive Media® Company (www.immersivemedia.com) makes 360° spherical full motion interactive videos with their Telemmersion® system, an integrated platform for capturing, storing, editing, managing spherical 3D or interactive video. Global Vision Communication (www.globalvision.ch) technology is used for Immersive Video Pictures and Tours. Their 360° interactive virtual tours can be integrated on websites. Individual panorama virtual tours are 360° HD-quality, clickable and draggable, and linkable to others through hotspots for navigation and display on maps and a directional radar. Their virtual tours are enhanced with sounds, pictures, texts, and hotpots.

The UC San Diego Calif. Institute for Telecommunications and Information Technology (Calit2, www.calit2.net), StarCAVE system is a five-sided VR room where scientific models and animations are projected in stereo on 360-degree screens surrounding the viewer. It projects onto the floors as well. The room operates at a combined resolution of over sixty-eight million pixels distributed over fifteen rear-projected walls and two floor screens. Each side of a pentagon-shaped room has three stacked screens, with the bottom and top screens titled inward by fifteen degrees to increase the feeling of immersion.

If coal mining machine operators' senses tell them the mixed reality (MR) environment our technology gives them is “real”, then these coal mining machine operators will be able to use their training and experience to expertly operate the machines in mining coal.

### SUMMARY OF THE INVENTION

Briefly, a method embodiment of the present invention of operating coal mine machinery that protects and maintains machine operators' health and well-being removes the machine operators to a clean, low-noise environment inside a refuge chamber. Inside, the operators have all the controls, cameras, audio, and informational displays they need to run continuous mining machines nearby and communicate mine-wide with other personnel. Cameras fitted to the mining machines provide straight-ahead views, ground penetrating radars fitted to the cutting drums measure the coal depths in the ceilings above, the floors below, and the coal face ahead. These measurements provide guidance data for the operators on informational displays, and the data from the ceilings and floors is used to drive computer graphics special effects to graphically represent the coal ceilings and coal floors on boundary rock. These are blended above and below the real straight-ahead camera views to provide the operator with an enriched picture of the good coal to mine ahead. Audio pickups on the mining machine allow the operator to hear and feel how the machine is functioning, just as operators have always employed their other senses.

These and other objects and advantages of the present invention will no doubt become obvious to those of ordinary skill in the art after having read the following detailed description of the preferred embodiments which are illustrated in the various drawing figures.

### IN THE DRAWINGS

FIG. 1 is a cross section of an underground coal mine with the equipment needed to follow a method embodiment of the present invention of operating coal mine machinery that protects and maintains machine operators' health and well-being;

FIG. 2 is a functional block diagram of the equipment needed to support a method of protecting the health and well-being of coal mine machine operators;

FIG. 3 is a cross sectional diagram of a cutting drum in a coal mine approaching a boundary rock layer that is measured by an RMPA and packed to restore the broken coal's dielectric constant by an incline ramp;

FIG. 4 is a flowchart diagram of a method of protecting the health and well-being of coal mine machine operators;

FIGS. 5A and 5B are perspective and cross sectional diagrams of a resonant microstrip patch antenna (RMPA) used in the cutting drums of coal mining machines in method embodiments of the present invention;

FIG. 6 is a diagram representing how little of the transmission energy of the GPR makes it to the reflection interface and survives for measurement as E_{R2};

FIG. 7 is a schematic block diagram of a radar transceiver and RMPA useful in embodiments of the present invention; and

FIG. 8 is a frequency plan diagram of the radar transceiver and RMPA of FIG. 7.

### DETAILED DESCRIPTION OF THE PREFERRED EMBODIMENT

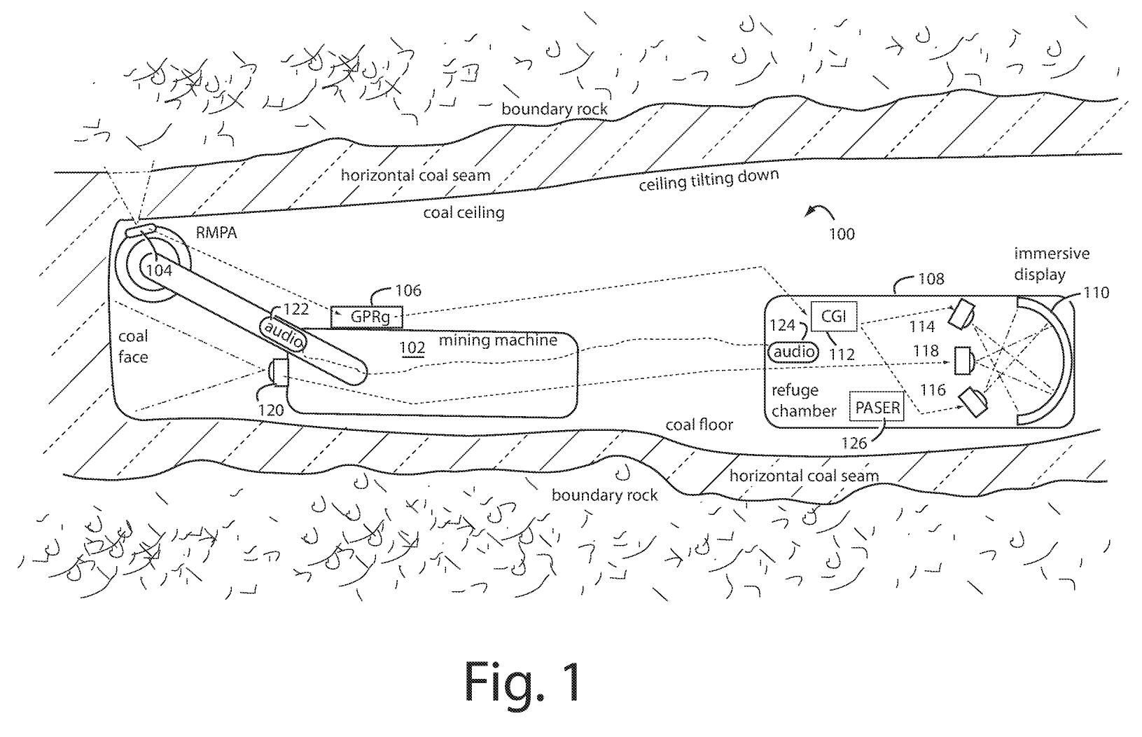

FIG. 1 represents the equipment needed to follow a method of operating coal mine machinery that protects and maintains machine operators' health and well-being. An underground coal mine 100 is worked here with a coal mining machine 102 fitted with a resonant microstrip patch antenna (RMPA) sensor 104 attached to its rotating coal cutting drum. The RMPA sensor 104 feeds radar measurements to a ground penetrating radar (GPRg) transceiver 106. This is linked by wireless routers to a nearby refuge chamber 108 with an immersive user display 110, here a horizontally projected concave three-dimensional (3D) vision dome. A computer generated imagery (CGI) animation system 112 receives boundary-layer coal seam thickness measurements from GPRg 106 and converts machine-guidance information to virtual reality (VR) displays of the coal ceiling and coal floor ahead of the coal mining machine 102.

A coal-floor video projector 114 and a coal-ceiling video projector 116 take CGI animation from CGI animation system 112 and project moving realistic images and informational “heads-up” displays including floor and ceiling simulations that include any estimates computed of horizontal coal seam tilting ahead. These projections further display boundary rock to coal thickness text displays.

A central video projector 118 provides straight-ahead and side views of the coal face in front of a frontend machine camera 120. The straight-ahead and side views of the coal face on immersive display 110 blend imperceptibly with those projected by coal-floor video projector 114 and coal-ceiling video projector 116. An audio transducer 122 picks up sounds and vibrations from the front of the coal mining machine 102 and reproduces them at safe sound levels inside refuge chamber 108 with another audio transducer 124. A comprehensive communications and people locating system is provided by our Post-Accident Self-Escape & Rescue (PASER) system 126. Our U.S. patent application Ser. No. 14/555,519, filed Nov. 26, 2014, provides further details and is incorporated herein in full by reference.

The refuge chamber 108 and especially the immersive display 110 provide the machine operators with effective float coal dust and noise protection while working inside the refuge chamber. The machine operators benefit from real-time video of machine operation and the geology ahead of mining with a heads-up display of real-time uncut distance to each boundary in inches. Usually the top six inches of coal in the roof will be too contaminated to be profitable or healthy to mine. A surround-sound reproduction of the machine acoustic noise and joystick vibration impression help immerse the machine operator in the work as it progresses. The heads-up displays further include gas and vibration spectrum graphics, and both roof and floor surface elevations ahead of mining.

RMPA sensor 104 is installed in a nest pocket milled into a thick steel gusset plate which is welded in between a ring and a vane of a coal cutting drum. The RMPA sensor 104 is protected behind a one inch thick polycarbonate lens. A metal perimeter frame about 4″×13″ is used to bolt the lens onto a ledge within the RMPA nest in the gusset plate. A mechanical wedge-elevation adjustment is used to fine tune the tilt and how far the trailing edge of unit rises above the surrounding surfaces of the drum end ring and vane. A mechanical wedging action is needed to compact the coal just ahead that was crushed and raked back against the face of the RMPA. Such compression acts to restore the crushed and raked back coal to expressing its original in-situ dialectic constant so that accurate readings by the RMPA can be maintained. A double-sideband (DSB) ground penetrating radar (GPRg) unit connected internally by cable or wirelessly to the RMPA measures the relative dielectric constant of the coal remaining uncut layer and instantly computes a measurement of the distance through to any rock boundary. We call this important measurement the Uncut Boundary Layer Thickness. The wedge compression and measurement have about seventeen milliseconds to complete at typical drum rotation speeds. RMPA sensor 104 calibrates itself in real-time with each measurement of the remaining uncut coal thickness.

There is an acoustic focal point disposed inside the refuge chamber 108 at the operator's seating position. The machine sounds are reproduced at low background levels as well as inserting detected mechanical vibrations into the operator joystick control. A heads-up display (HUD) of the noise spectrum and mechanical vibration helps the operators to use their experience and intuition to determine the on-set of imminent machine failures.

Refuge chamber 108 is best designed as elongated cylinder with rounded hemispherical ends, and a skid mounted flat bottom. One hemispherical end is used for the operators chair and the immersive display 110. The opposite end has an extended flat bottom tube design with a sealed door. Operating crews of less than eight are typical.

The materials selected for the refuge chamber 108 design must not produce toxic gas when subject to MSHA certification flame tests, including pressure wavefront and heat withstanding requirements. The height of coal seams entries are cut during development for man and machine clearances; often times, six feet high or more. The refuge chamber 108 includes a flame proof enclosed battery with capacity enough to support forty-eight hours of stand-down operation when the ventilation system is shut down.

MSHA requires mines to periodically train in their MSHA approve escape plan, the post-accident self-escape and rescue (PASER) radio communications and tracking (C&T) system electronics was developed for digital through-the-earth and mine-wide transmission. MSHA requires “life lines” to be installed in the designated escape ways to guide self escaping miner through smoke and toxic gas filled entries. The escaping miners use VHF/UHF transceivers to communicate with the PASER system.

Miners consider conventional refuge chambers to be too confining. Adding immersive display 110 can change this perception because the control room graphics are replicated in every required refuge station. Refuge chambers 108 are located on escape routes throughout the mine. Underground managers and supervisors are expected to use such refuge chambers 108 routinely for their primary sources of information underground. Mining machines are expensive and very dangerous. The geology confronting these machines is a dark unknown. Repetitious work place routine dulls miners' senses. But the dangerous realities never relent. The original HS-3 horizon sensor had a graphical user interface that was positioned on the frame of a continuous mining machine. So too the refuge chamber 108 must be mounted near the continuous mining machine, Refuge chambers which arc required at intervals along min e escape ways arc typically stocked within oxygen supplies and self-contained, self-rescuers (SCSR).

A method embodiment of the present invention that uses the elements of FIG. 1 begins by removing coal mine machine operators from unlimited noise and float coal dust exposures alongside a coal mining machine to inside a less noisy and relatively float coal dust-free environment inside a nearby refuge chamber. Then, video imaging the view ahead of the coal mining machine with a camera mounted to it and providing a video link to a user display inside the refuge chamber. Next, engaging the coal mining machine operators in an immersive experience and virtual reality video display on a horizontally projected concave three-dimensional (3D) vision dome. A step for preventing mining-out-of-seam by displaying to the coal mine machine operators a computer generated graphic and informational display included in the user display of a boundary-layer coal thickness computation derived from a ground penetrating radar measurement provided by a resonant microstrip patch antenna (RMPA) attached to a coal cutting drum of the coal mining machine. Then, stabilizing the boundary-layer coal thickness computation by mechanically packing loose coal just cut in front of the RMPA with a mechanically adjustable incline ramp attached to the coal cutting drum. And, reproducing the sounds and vibrations present at the coal mining machine inside the refuge chamber for the coal mine machine operators to hear and feel with audio transducers that limit sound levels to predetermined safe limits, and that add to the immersive experience and virtual reality video display on the three-dimensional (3D) vision dome. And, increasing a feeling of virtual reality immersion for the coal mine machine operators by projecting both floor and ceiling displays in the user display that include computer generated image (CGI) animation of coal seam tilting ahead as estimated from boundary-layer coal thickness computations derived from the ground penetrating radar measurements of the RMPA.

One method uses short-wavelength reflections of 100-MHz to 2,000-MHz and long-wavelength scattering of the electro-magnetic radio energy of the radio broadcast transmitter from buried objects underneath in layered soils with a surface-based measurement of buried-object signals using at least a phase-coherent elimination of ground surface reflection noise of at least sixty decibels in digital signal processing with a field programmable gate array (FPGA).

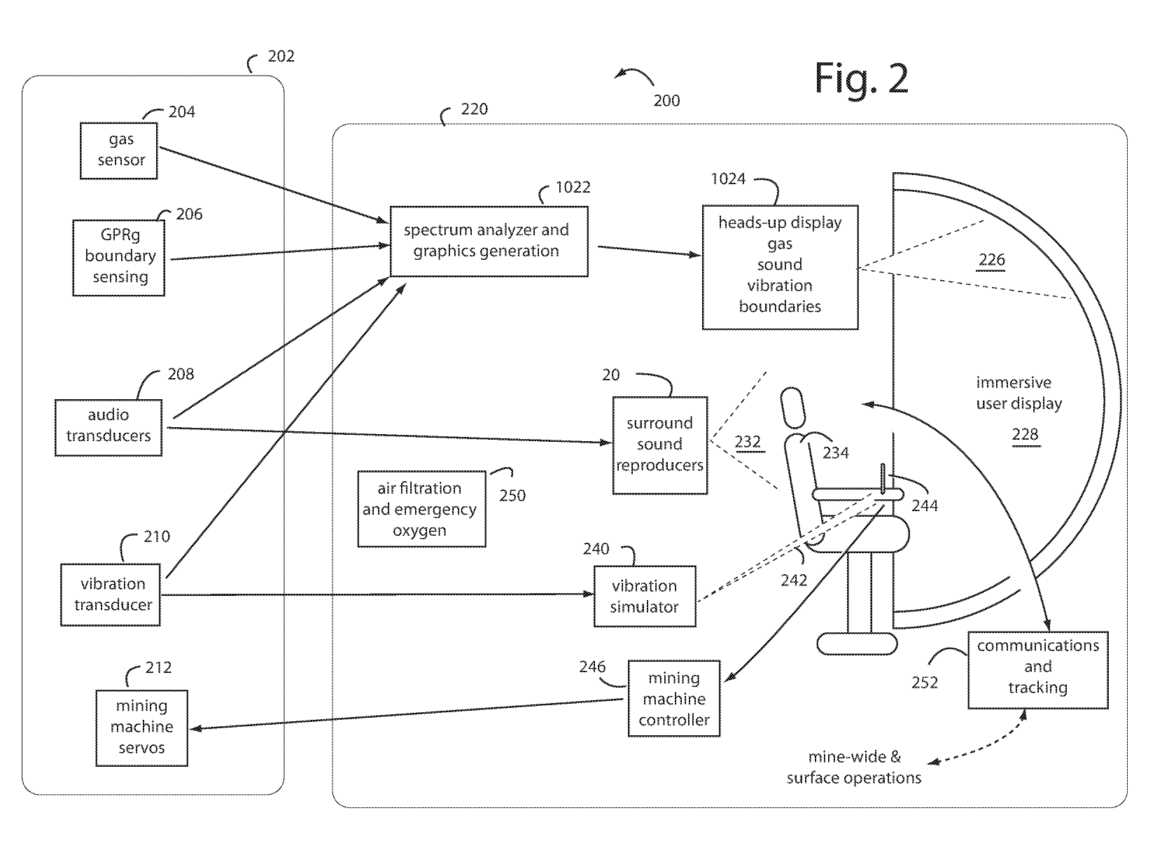

FIG. 2 represents the equipment needed to support a method 200 of protecting the health and well-being of coal mine machine operators. A coal mining machine 202 is equipped with gas sensors 204, GPRg boundary sensing radar 206, audio transducers 208, vibration transducers 210, and mining machine control servos 212. The coal mining machine 202 works in a humid, hot, dusty, inhospitable environment underground in a coal mine that is generally uncomfortable, unhealthy and dangerous to mining machine operators. The coal mining machines themselves can generate ear-splitting and hazardous sound levels during operation.

Method embodiments of the present invention relocate the work stations of these mining machine operators to the relatively safer, quieter, and much less noisy environment inside a sealed refuge chamber 220. A spectrum analyzer and graphics engine converts electronic signals from the gas sensors 204, GPRg boundary sensing radar 206, audio transducers 208, and vibration transducers 210, into text displays and spectrum graphics for a heads-up display projector 224. Such produces a video image overlay 226 on the inside of a hemispherical, immersive user display 228. The audio transducers 208 also feed surround-sound reproducers 230 that recreate a realistic sound immersion 232 that safely replicates what an operator at the coal mining machine would hear, but without the hazards of unlimited sound levels. An acoustic focus coincides with a machine operator's working station 234. The vibration transducers 210 are linked to a vibration simulator 240 that outputs shaking 242 to be felt in a joystick control 244. The joystick control 244 connect back to the mining machine servos 212 that allow the operator full control of the mining machine 202.

An air filtration and emergency oxygen unit 250 removes float coal dust and keeps oxygen levels inside at safe levels. A communications and personnel tracking system 252 provides mine-wide communication and automatic tracking and locating of work shift personnel.

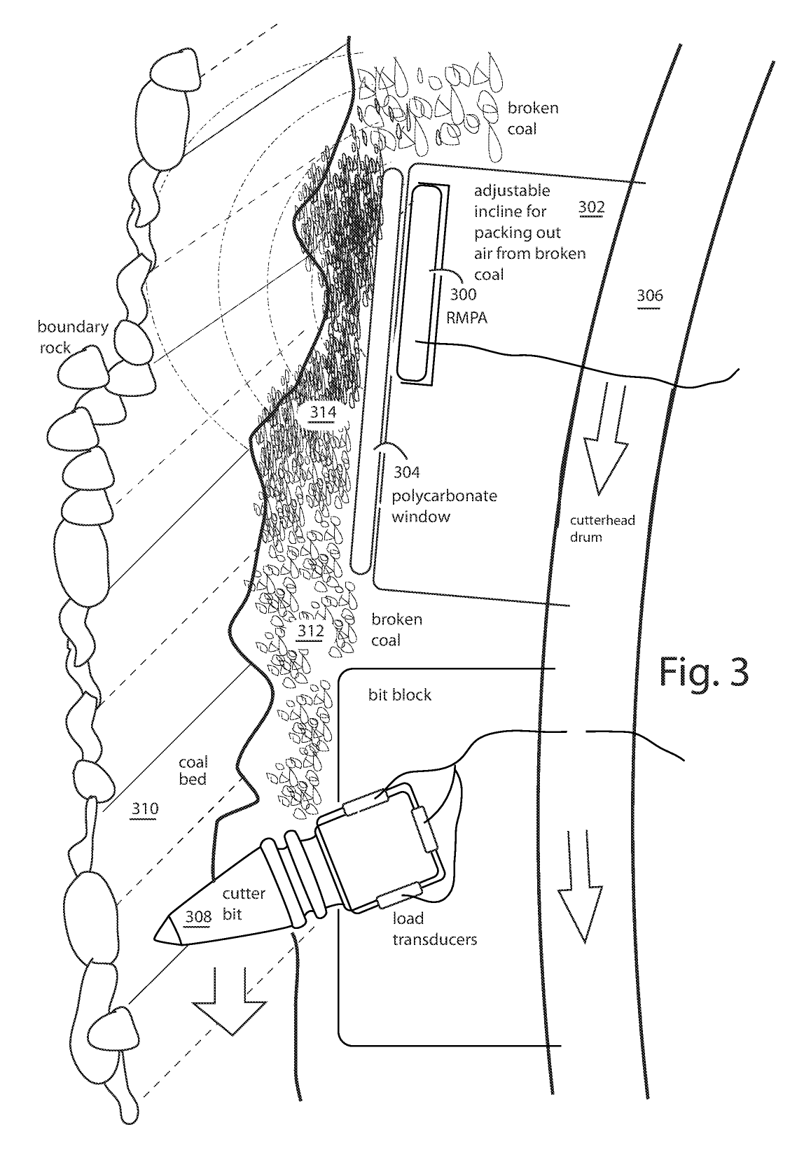

FIG. 3 represents the special methods employed for a RMPA sensor 300 to stay in calibration during coal cutting. FIG. 3 is a close-up of what's Napping with RMPA sensor 104 in FIG. 1, especially working inside along the ceiling and roof of a horizontal coal seam. RMPA sensor 300 is inlaid into a pocket of an adjustable incline ramp 302 behind a protective polycarbonate window 304. These mount to a cutterhead drum 306 on an outside face behind a cutter bit 308.

The cutterhead drum 306 cutter bits 308 bite hard into a coal bed 310 as the drum turns. Solid coal in its natural deposits has a well understood dielectric constant, and calibrations and measurements of it by RMPA sensor 300 will produce reliable coal-thickness-to-boundary-rock measurements. But a broken and loose coal 312 will adversely affect the RMPA calibration because so much air is mixed in with the coal float coal dust and particles. The mixed dielectric constant approaches that of air, and in wild fluctuations.

The incline face angle presented by adjustable incline ramp 302 causes the broken and loose coal 312 to pack out the air into a compressed coal pack 314 that returns the overall dielectric constant to that of solid coal. Some adjustments to get this right are needed and should be provided on the cutterhead drum 306.

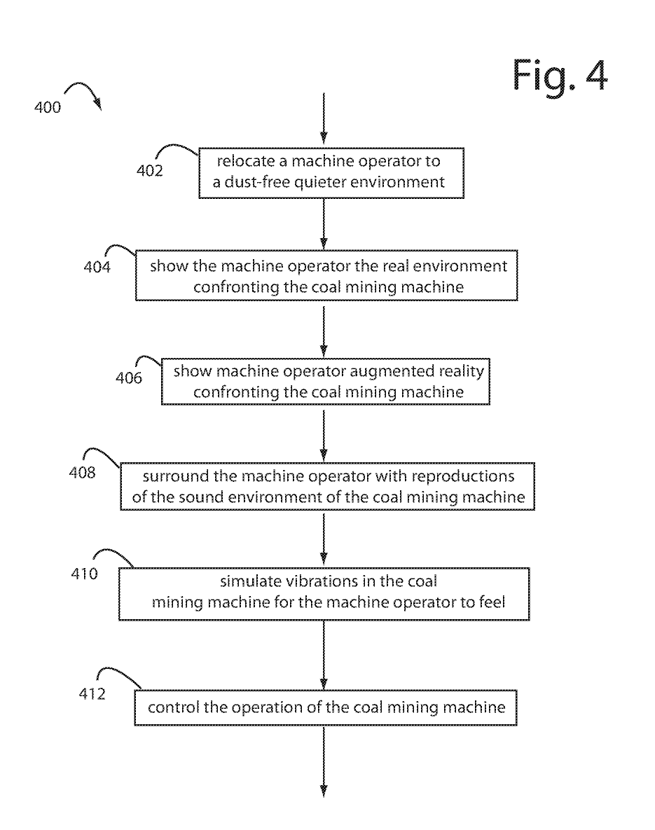

FIG. 4 represents a method of protecting the health and well-being of coal mine machine operators, and is referred to herein by the general reference numeral 400. Method 400 begins with a step 402 of relocating a machine operator's working position to a dust-free quieter environment inside a refuge chamber nearby a coal mining machine. A step 404 shows a machine operator in the working position a video of the real environment confronting the coal mining machine and a front mounted camera. A step 406 shows the machine operator an augmented reality confronting the coal mining machine using computer generated imagery (CGI) animation derived from the floor and ceiling boundary rock measurements provided by a ground penetrating radar with a resonant microstrip patch antenna (RMPA) mounted in a cutting drum of the coal mining machine. A step 408 surrounds the machine operator with reproductions of the sound environment of the coal mining machine with sound transducers. A step 410 simulates vibrations in the coal mining machine for the machine operator to feel in a joystick controller. A step 412 controls the operation of the coal mining machine through the joystick controller to machine control servos in the coal mining machine.

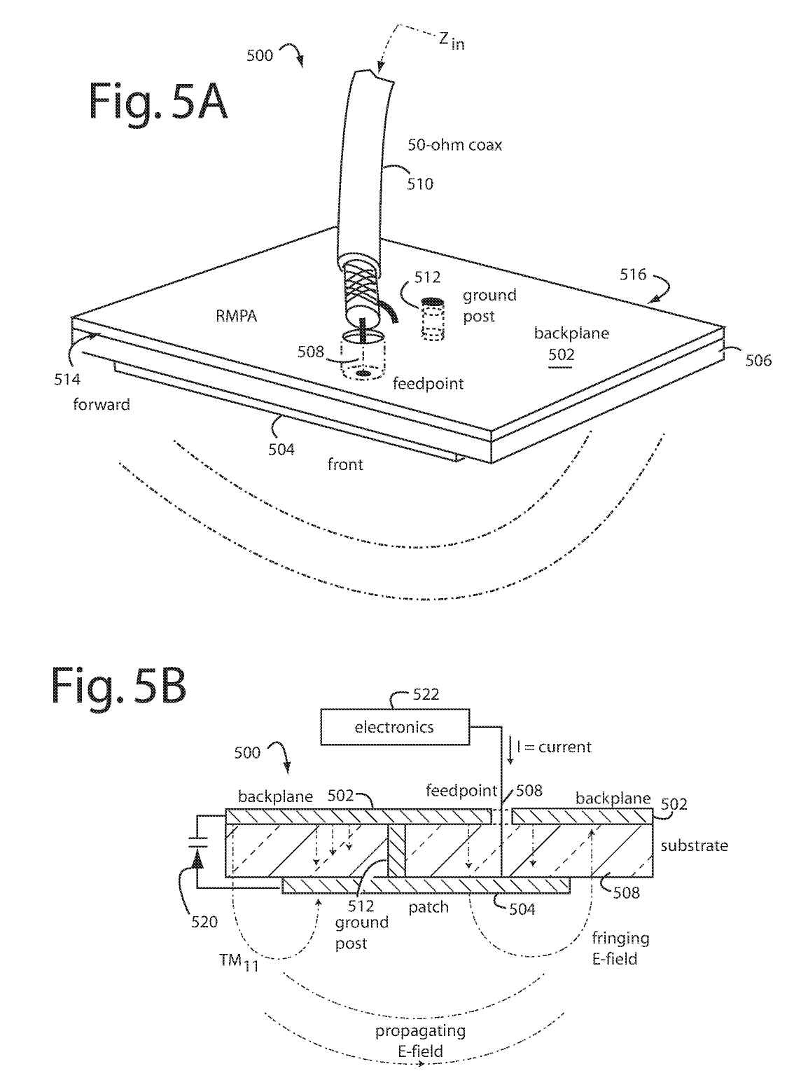

FIGS. 5A and 5B represent the details of a resonant microstrip patch antenna (RMPA) sensor 500 the same as RMPA sensor 104 in FIG. 1. These resonant microstrip patch antennas are detailed further in our United States Patent Application Publication US 2014/0306839, published Oct. 16, 2014, and titled ELECTROMAGNETIC DETECTION AND IMAGING TRANSCEIVER (EDIT) AND ROADWAY TRAFFIC DETECTION SYSTEM, application Ser. No. 13/862,379, filed Apr. 13, 2013, and incorporated herein in full by reference.

FIG. 5A represents one way we constructed a resonant microstrip patch antenna 500 using common FR4 printed circuit board material. A copper-foil backplane 502 and radiating patch 504 are separated by an epoxy substrate 506. A feedpoint 508 is drilled through the backplane 502 and substrate 506 so a 50-ohm coaxial cable can be attached to the radiating patch 504. A groundpost 512 is constructed by drilling and plating a copper via. The relationship of the feedpoint 508 to the groundpost 512 creates a forward radiating edge 514 and an aft radiating edge 516. The resonant microstrip patch antenna has a characteristic input impedance (Zᵢₙ) and resonant frequency (F_{R}) that are a function of the dielectric constant of substrate 506, objects in the radiated field, the separation distance of backplane 502 and patch 504, the distance between feedpoint 508 to the groundpost 512, and the plan dimension of patch 504. Herein, these all add up to a resonant frequency in the range of 100-MHz to 2-GHz, and a Zᵢₙ of about 50-ohms when the radiation field is substantially comprised of air. Varactors 520 or other types of trimming capacitors can be added around the edges of resonant microstrip patch antenna 500 to fine-tune its resonant frequency.

It is important to good operation in this use here that the antenna be narrow band. Conventional antennas used in the GPR's we reference herein typically employ wideband antennas.

In the illustrated configuration, the resonant microstrip patch antenna is fed a constant frequency and the varactors are tuned to keep it at resonance despite changes in the media environment surrounding the resonant microstrip patch antenna. The “auto-correction” voltages sent to the varactors to keep the balance will therefore respond proportionally to changes in the media environment. The resonance is verified by observing minimas in the Zᵢₙ. Interpretations of the placement and relative movements of buried objects can, in one embodiment, be made by tracking the correction voltages sent to the varactors 520 necessary to minimize Zᵢₙ.

Scattering parameters (s-parameters) describe the scattering and reflection of traveling waves when a network is inserted into a transmission line. Here, the transmission line includes the soils and buried objects. S-parameters are normally used to characterize high frequency networks, and are measured as a function of frequency. So frequency is implied and complex gain and phase assumed. The incident waves are designated by the letter aₙ, where n is the port number of the network. For each port, the incident (applied) and reflected waves are measured. The reflected wave is designed by bₙ, where n is the port number. When the incident wave travels through a network, its gain and phase are changed by the scattering parameter. For example, when a wave a₁ travels through a network, the output value of the network is simply the value of the wave multiplied by the relevant S-parameter. S-parameters can be considered as the gain of the network, and the subscripts denote the port numbers. The ratio of the output of port-2 to the incident wave on port-1 is designated S₂₁. Likewise, for reflected waves, the signal comes in and out of the same port, hence the S-parameter for the input reflection is designated S₁₁.

For a two-port network with matched loads:

S₁₁ is the reflection coefficient of the input;

S₂₂ is the reflection coefficient of the output;

S₂₁ is the forward transmission gain; and

S₁₂ is the reverse transmission gain from the output to the input.

S-parameters can be converted to impedance by taking the ratio of (1+S₁₁) to (1−S₁₁) and multiplying the result by the characteristic impedance, e.g., 50-ohms or 75-ohms. A Smith chart can be used to convert between impedance and S-parameters.

The frequency and impedance, or reflection coefficient (S₁₁), of resonant microstrip patch antenna 500 are measured to provide sensor information and interpretive reports. resonant microstrip patch antenna 500 is electronically tuned by a sensor controller either adjusting oscillator frequency and/or varactors to find the resonant frequency of the resonant microstrip patch antenna each time a measurement is taken. The S₁₁ (reflection coefficient) parameter is measured in terms of magnitude. The sensor controller seeks to minimize the magnitude of S₁₁, meaning resonant microstrip patch antenna 500 is near its resonant point and 50-ohms.

During an automatic steady state calibration, an iterative process is used in which a sensor controller seeks a minimum in S₁₁ by adjusting the applied frequency through an oscillator. Once a frequency minimum for S₁₁ is found, sensor controller adjusts a bias voltage on varactors connected to the edges of resonant microstrip patch antenna 500. The voltage variable capacitances of varactors are used to fine tune resonant microstrip patch antenna 500 into resonance, and this action helps drive the impedance as close to 50-ohms as possible. Sensor controller simply measures the S₁₁ magnitude minimum. Once voltage adjustments to varactors find a minimum in S₁₁ magnitude, the process is repeated with very fine adjustment steps in an automatic frequency control to find an even better minimum. The voltages to varactors are once again finely adjusted to optimize the minimum.

After calibration, an independent shift away from such minimum in S₁₁ magnitude means a buried object is affecting the balance. The reflection coefficient (S₁₁) will change away from the original “calibrated” resonance value. Typically a buried object passed overhead within the field will cause a peak maximum in the measured data. The rate of change of the measured signal in the area is directly related to the speed of the vehicle carrying resonant microstrip patch antenna 500.

S₁₁ has both magnitude and phase, a real and imaginary part. Changes in magnitude indicate a disturbance in the EM-field of resonant microstrip patch antenna 500, and changes in the phase provide the directionality of travel 110-113. resonant microstrip patch antenna 500 is a linearly polarized antenna, the fields on one edge of resonant microstrip patch antenna 500 are 180-degrees out of phase from the field on the other edge. With a proper alignment of resonant microstrip patch antenna 500 in situ, buried objects passing in front of resonant microstrip patch antenna 500 from left to right, will produce a phase signature that is 180-degrees out of phase from other objects moving right to left. The phase at resonance can be corrected to provide a constant 180-degree shift.

FIG. 5B schematically represents resonant microstrip patch antenna 500 taken through a normal plane that longitudinally bisects both the ground post 512 and feedpoint 508. Varactor 520 is typical of many that can be connected to be voltage-controlled by electronics controller 522 to enable fine tuning of the resonant frequency of resonant microstrip patch antenna 500 to help with calibration and measurement sensing. The electronics controller 522 is able to measure parameter S₁₁ at the feedpoint 508 and thereafter issue interpretive reports.

At resonance, the electromagnetic fields radiate away from resonant microstrip patch antenna, as shown in FIG. 5B. A linearly polarized electric field fringes from the edges of the metalized, copper foil parts of resonant microstrip patch antenna 500. Such type of polarization is an important operational element, this polarization enables a directional indication. As applied here, the antenna radiation pattern has a very broad 3-dB beam width of ±30 degrees from the perpendicular to the plane of patch 504. This pattern is important in the present applications because the wide antenna pattern allows a large area to be electronically swept.

The RMPA coaxial cable 510 coupling probe location 508 distance from the grounding pin 512 determines the resonance impedance of the sensor. The probe distance from the grounding pin is adjusted for RMPA S11 impedance of 50-ohms, impedance matching RMPA to the 50-ohm directional coupler. The distance adjustment conditions are established with a forty millimeter (1″) thick coal layer stacked above oil-shale boundary rock. The standard sensor detection sensitivity degrades when the probe S11 impedance varies from 50-ohm, due to directional couple mismatch losses. The sensor can be reduced in length by one-half by substituting the grounding pin with a copper shorting bracket connecting the upper and lower copper plates, creating a grounded edge and single-radiating edge sensor. The single-radiating sensor will be evaluated to explore its detection sensitivity and feasibility in this application.

The magnetic field (H-fields) lines of force travel away from RMPA edges. One advantage of RMPA sensors is their minimum back-lobe antenna pattern, favorable for surface mounting on the gusset plate between the vane and ring on the cutting drum. The electric field lines of force are polarized between the slightly conductive relative dielectric constant insulator existing between the upper and lower copper microstrip plates. The E-field line of force terminate on mobile negative charges and originates from mobile positive charges. Vertically polarized E-field lines of force are established by a center conductor of the unshielded part of the coaxial cable probe. Insulation is predominated by bound and mobile charge. The mobile charges are accelerated by the alternating polarity of E-field lines of force causing dielectric current (IC) flow. Energy is lost when mobile charge collides with the bound charge in the dielectric material (Ceramic™-10). The cable is connected to a directional coupler and driven by DSB GPRg 106 transmitter section. The magnitude of the spatial variation observed in E-field line of force reach maximum value at ¼ wavelength from the grounding pin or edge.

The fringing E-field lines of force are oppositely polarized with respect to each other at the radiating edges of the upper copper plate of the RMPA sensor. The physical length of upper copper plate determines the 1st resonance frequency wavelength is ½ wavelength in the insulator. EM wavelength in the RMPA slightly conducting dielectric insulator is given by λ=C/f[∈_{D}]^{1/2}. The polarized fringing E-field lines of force add together forming a horizontally polarized E-fields line of force traveling away from the upper copper plate of the RMPA sensor following the orthogonal path into the coal (coal) layer. The horizontally polarized E-field propagation constant is given by K=β−ια where α is the attenuation rate in dB per m and β is the phase constant in radians per m in the coal layer. By the reciprocity theorem, the reflected waves from the ATB and TOSB interfaces return back to the directional coupler following the same path. The forward are returning reflected EM field components are phase coherent and occur simultaneously on the same path observable as standing waves. The directional coupler reviving port is connected to the DSB GPRg coaxial terminal.

The RMPA quality factor (Q) is defined by the ratio of peak energy stored to energy loss per cycle. Energy loss is the sum of energy dissipated as heat in the dielectric insulator, copper plates and radiated via the fringing fields. The losses also include dissipation loading transformed from external directional coupler circuits and geology. The circuit-Q_{CKT} is defined as the resonate frequency (ω_{O}) divided by the 3-dB bandwidth (BW) of the RMPA operating in the measurement geology environment. The circuit-Q depends on the relative dielectric constant of the dielectric material itself, making up the layered insulator between the copper plates. Typically, the circuit-Q is near 100 for an insulator relative dielectric constant of 2.2 to 10. If Q is significantly increased, the radiated EM energy decreases. The RMPA 3-dB bandwidth must accommodate the occupied frequency domain spectral DSB components bandwidth of the modulated waveform.

The physical size of the RMPA sensor is related to the uncut coal on-set thickness (O-ST) and the detection sensitivity rapidly increases on approach to the boundary) is determined by the sensor operating frequency (f0). The operating frequency establishes the O-ST at ¼ wavelength thickness in coal (meters). At an operating frequency of 400 MHz, the wavelength (λ_{T}) in coal (∈_{T}=7.5) is 275 mm (10.8 inches). The round trip path distance through the coal layer is equal to one-fourth wavelength in coal. The O-ST occurs at 69 mm (2.7 inches) but if the RMPA sensor is operated at 200 MHz; the O-ST is 138 mm (5.4 inches). The physical length of the RMPA sensor upper copper plate and its radiating edges is ½ wavelength in the dielectric separating the upper and lower copper plates of the sensor (the insulator relative dielectric constant (□R) is equal to 10 instead of 7.5 in coal), the 400 MHz operating frequency one-half wavelength distance is 118 mm (4.67 inches). If the operating frequency of RMPA is reduced to 200 MHz, then the length of the sensor copper plate length is 236 mm (9.34 inches). Either of these copper plate length appear to be reasonable for mounting on the cutting drum. To achieve the 203 (8 inches) O-ST requirement the operating frequency must be reduced to 135 MHz requiring an upper copper plate length of 452 mm (13.8 inches). A sensor substrate relative dielectric constant of 22 reduces the upper copper plate length back to 236 mm (9.34 inches). For gusset plate RMPA sensor application in coal mining, O-ST of 203 mm (8 inches) requires an optimum operating frequency is 300 MHz. The RMPA length reduces to 188 mm (6.2 inches) for a sensor substrate relative dielectric constant of 10.

The gusset plate RMPA sensor will be a minimum of 2 inches thick and welded or bolted to both the vane and ring 4 inch thick vertical edges. The sensor surface and fragmented trona interface layer are loaded by the drum-ranging arm down (up) force vector with horizontal and vertical components. Eventually this force and coefficient of sliding friction will need to be determined. The cut-fragmented trona layer will expand in volume resulting in decreased relative dielectric constant of the trona layer. If the gusset plate surface elevation gradient gradually increases from the gusset plate intersection with the vane-ring intersection to the trailing edge, momentary compression of the fragmented trona layer will with drive the relative dielectric constant back to the in-situ value. The gusset plate-tilt angle can be adjusted, with mechanical adjustment to optimize cut trona layer fragmentation compression during the 22.7 millisecond cut-time interval.

The sine SCGRE signal processing also addresses the fragmentation issue so that trona relative dielectric constant can be determined. Re-compression of fragmentation during measurement assists in reducing the error. SCGRE signal processing suppresses fragmentation reflection from the cut trona layer. The measurement accuracy can be additionally be improved by introducing adaptive averaging in signal processing. The shearer travels thirty-five feet per minute, rotating at forty-five RPM. The face sampling distance is 0.78 ft. We can apply statistical analysis to bind the measurement error.

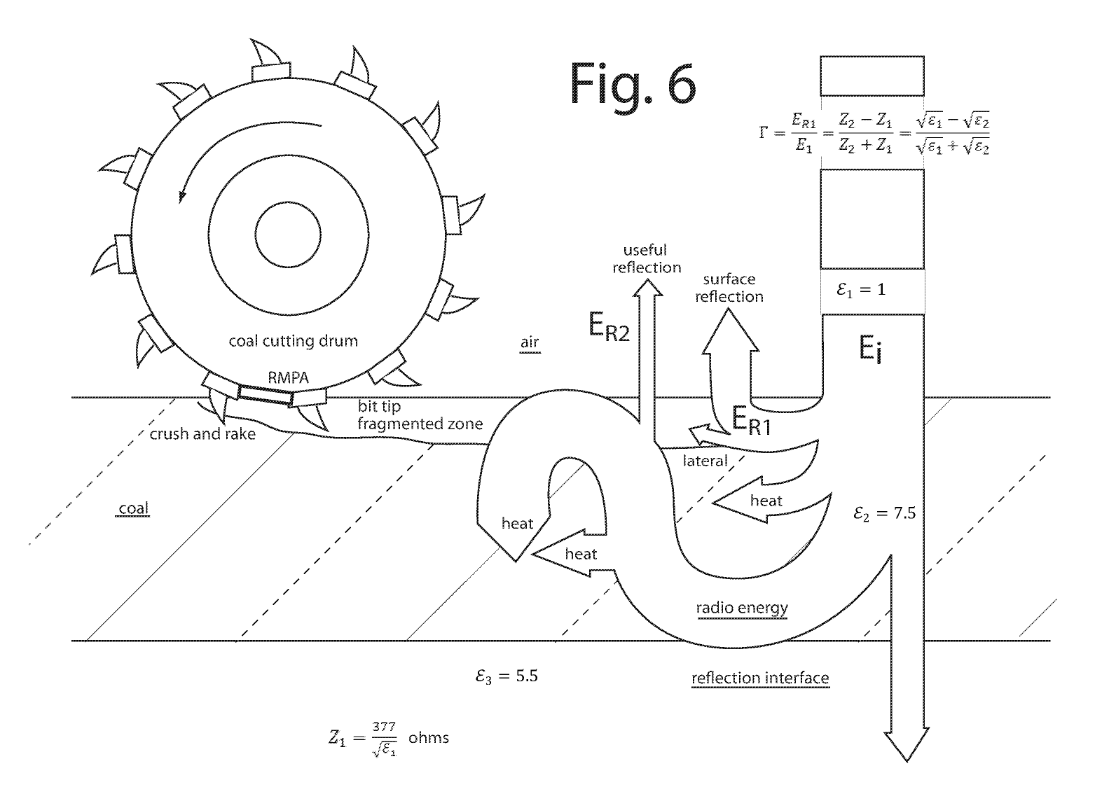

FIG. 6 represents how little of the transmission energy of the GPR makes it to the reflection interface and survives for measurement as E_{R2}.

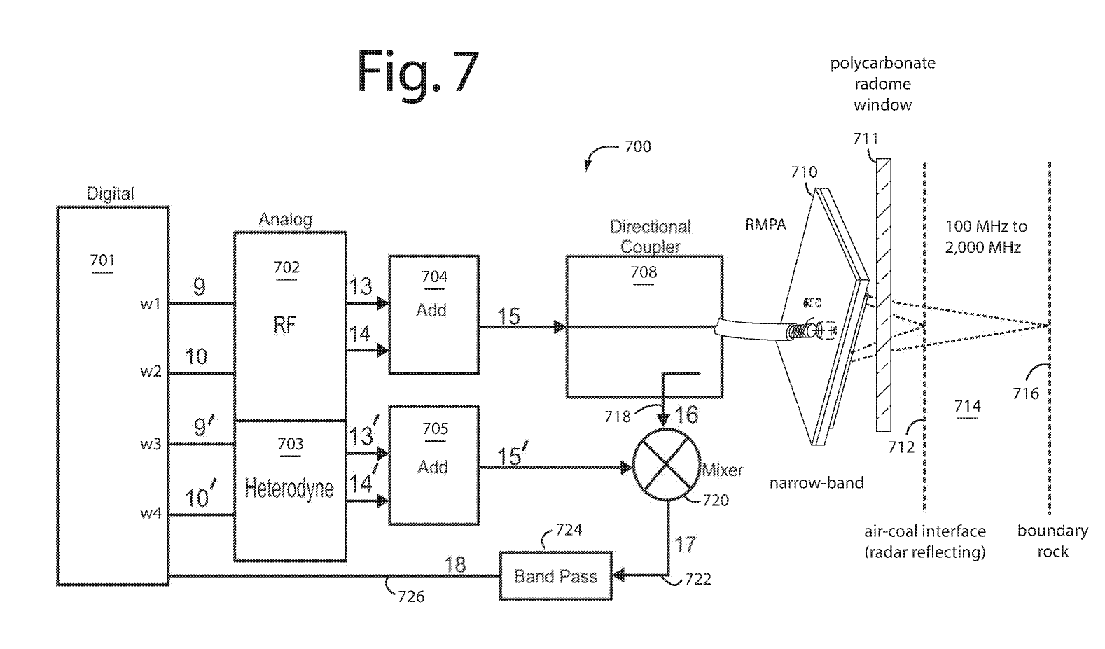

FIG. 7 represents a GPRg 106 implementation in a software-defined transceiver radar (SDTR) 700 that includes a digital signal processor 701, an analog radio frequency stage 702, a heterodyne frequency synthesizer 703, an RF adder 704, a local oscillator adder 705, a directional coupler 708, and an resonant microstrip patch antenna 710. These all launch RF transmissions through a protective polycarbonate radome window 711 into a ground surface 712, into soils 714, and reach a buried object 716. Return reflections are collected by a port 718 and beat down by a mixer 720 into an intermediate frequency 722. This is filtered by a bandpass 724 for processing by DSP 701.

In a prototype implementation of a software defined transceiver radar, the analog printed circuit board included a quadrature up converter, RF power amplifier, coupler (for a monostatic radar), phase locked loop (PLL), or several quad DOSs (Analog Device AD9959) and a down converter.

Software-defined transceiver radar (SDTR) 700, included digital and analog printed circuit boards (PCBs) for 701, 702, and 703. The digital PCB 701 produces four synthesized digital frequencies ω1, ω2, ω3, and ω4, respectively described by equations 7, 8, 7′, and 8′, in Table-V. Analog PCB 702 uses these to produce the radio frequency (RF) signals described by equations 13 and 14, and analog PCB 703 produces heterodyne signals described by equations 13′ and 14′, of Table-V (in our U.S. Pat. No. 7,656,342, issued Feb. 2, 2010, and titled, DOUBLE-SIDEBAND SUPPRESSED-CARRIER RADAR TO NULL NEAR-FIELD REFLECTIONS FROM A FIRST INTERFACE BETWEEN MEDIA LAYERS). Adders 704 and 705 sum these to produce a transmitter signal described by equation 15 and a synchronous mixer signal described by equation 15′ of Table-V. A directional coupler 708 sends the transmitter signal through for launching into a radar media by an antenna 710. A first interface 712, a coal seam 714, and a second interface 716 are typical in the radar media. Any return reflections 718 extracted by directional coupler 708 are described by equation 16 of Table-V (in US and are detected by a mixer 720. The mixer output 722 is described by equation 17 of Table-V. A bandpass filter 724 removes the carrier and one of the sidebands for an output signal 726, and is described by equation 18 of Table-V. The digital PCB 701 then interprets signal 726 to estimate the character of first interface 712, coal seam 714, and second interface 716.

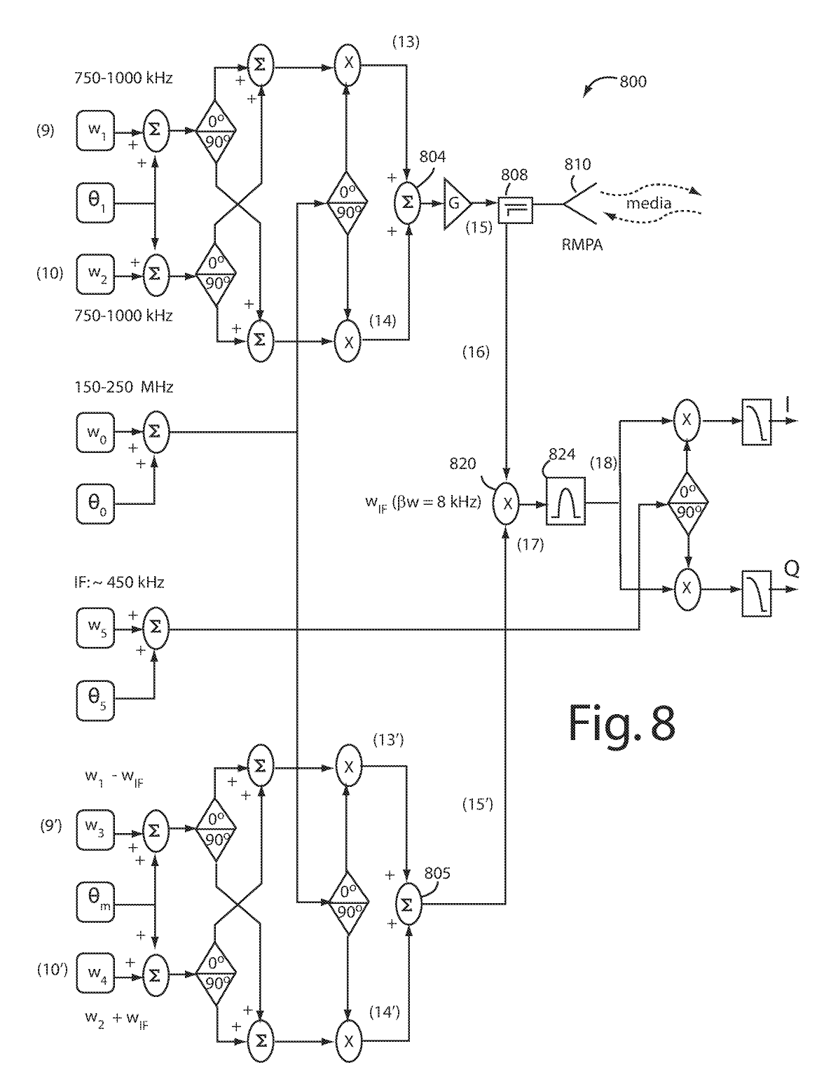

FIG. 8 diagrams how the various equations of Table-V can be interrelated, and suggests how the circuitry of SDTR 700 can be configured to do the required signal processing. The inputs w1 and w2 are in the range of 750-1000 kHz and are summed with θ1 using phase splitters to produce upper and lower sidebands with a completely suppressed carrier at the output of an adder 804. Such is the equivalent of adder 704 in FIG. 7. This is amplified by an amplifier (G) before being applied to a directional coupler 808 and antenna 810. Such are equivalent to directional coupler 708 and antenna 710 in FIG. 7.

The mixer 720 must accommodate a reflection of +0-dB from the first-interface 712 reflected EM wave that is up to 80-dB greater than the second interface 716 reflected EM wave. This requires a radar receiver dynamic range greater than 80 dB (10,000). The mixer 720 performs sinusoidal waveform multiplication. The band pass filter 724 rejects all mixer output frequencies except the intermediate frequency (IF). The directional coupler 708 recovers the reflected wave. Phase-coherent detection is achieved by mixing the DDS with the reflected point signal and bandpass filtering the mixer output signal. An important feature of the phase-coherent detection scheme is that the in phase (I) and quadrature (Q) terms are simultaneously measured in the digital electronics 701. Simultaneous measurement improves noise immunity.

Surface reflection suppression is processed as illustrated in FIG. 8, an algorithm 800. Such is described in great detail in our U.S. Pat. No. 7,656,342, issued Feb. 2, 2010, and titled, DOUBLE-SIDEBAND SUPPRESSED-CARRIER RADAR TO NULL NEAR-FIELD REFLECTIONS FROM A FIRST INTERFACE BETWEEN MEDIA LAYERS. And such are incorporated herein by reference.

FIG. 8 diagrams how the various equations of Table-V in the Reference can be interrelated, and suggests how the circuitry of SDTR 700 can be configured to do the required signal processing. The inputs w1 and w2 are in the range of 750-1000 kHz and are summed with θ1 using phase splitters to produce upper and lower sidebands with a completely suppressed carrier at the output of an adder 804. Such is the equivalent of adder 704 in FIG. 7. This is amplified by an amplifier (G) before being applied to a directional coupler 808 and antenna 810. Such are equivalent to directional coupler 708 and antenna 710 in FIG. 7.

The DSB GPRg with signal processing and phase coherent quadrature detection electronics signal processing suppresses the first interface reflection so that the coal-oil shale interface reflection can be detected and measured to determine uncut coal depth.

The double-sideband gradiometric ground penetrating radar resonant microstrip patch antennas are driven with two different phase-coherent reflected double-sideband waveform signals from the cluttering geology air-to-soil interface (cluttering geologic noise) caused by variations in moisture, type of buried object rock, and any fragmentation of the coal oil shale buried object rocks. The early arrival time cluttering geologic noise from the air-to-soil interface interface has an average magnitude of −6.6 dBm. The detection problem now becomes evident. The magnitude of the late arrival time (late arrival time) reflected double-sideband signal (S) from the floor coal oil shale buried object interface is a factor of 5.5 times less than the early arrival time double-sideband signal reflected cluttering geologic noise from the air-to-soil interface interface.

There is a significant difference in round trip travel time (t) between the early arrival time cluttering geologic noise and the late arrival time double-sideband signal (S) reflected from the coal oil shale buried object interface. The electromagnetic wave velocity (v) in the coal layer is C (3×10⁸ m/s) divided by the square root of the relative dialectic constant of coal) and slows down to 1.09×10⁸ m/s. When the cutting edges are 609 mm (1 foot) from the coal oil shale buried object interface, the round trip travel time (tₜᵣₒₙₐ oil shale buried object) is 5.6 nanoseconds. The E_{RT} double-sideband signal round trip travel time (t_{ATB}) is less than 0.05 nanoseconds.

The double-sideband gradiometric ground penetrating radar transmission and receiving paths are not totally isolated from each other, and this makes detection more difficult. When a single resonant microstrip patch antenna sensor is used in a double-sideband gradiometric ground penetrating radar design, an integrated directional coupler (DC) is needed. The directional coupler has a directivity specification that seldom exceeds −30 dB. The magnitude of early arrival time coupler transmit path leakage double-sideband signals is −30 dBm in the receiver channel.

$$Γ = \frac{{E}_{R 1}}{{E}_{1}} = \frac{{Z}_{2} - {Z}_{1}}{{Z}_{2} + {Z}_{1}} = \frac{\sqrt{{ɛ}_{1}} - \sqrt{{ɛ}_{2}}}{\sqrt{{ɛ}_{1}} + \sqrt{{ɛ}_{2}}}$$

$${Z}_{1} = \frac{377}{\sqrt{{ɛ}_{1}}}$$

The magnitude of the illumination electromagnetic wave (EM) electric field (E I-field) component is oftentimes more than the magnitude greater than the reflected ER-field from the first surface air-coal boundary (ATB) interface. The ratio of the sensor signal (S) to the interface spatial cluttering geology noise ratio S/cluttering geologic noise=E_{R}/E_{I}<1. Reliable detection requires a ratio, S/cluttering geologic noise>5.5, or +13 dB. Part of the EM wave source of energy magnitude of DSB GPRg transmitter section output signal is referenced to 0 dBm (e.g., a reference voltage of 0.337 volt producing one milliwatt across 50-ohm resistor) travels through the air-coal boundary (ATB) with an interface transmission loss of 6.4 dB. The attenuation rate through coal is 0.08 dB per ft. (300 MHz, σ_{T}=0.0005 Siemens per meter with a relative dielectric constant [∈_{T}=7.5]). The “heat” loss is negligible for thin 110 millimeter coal layers. The EM waves traveling through coal layer has a magnitude of −6.4 dBm and illuminates the underground coal interface with oil-shale boundary (boundary). The problem is illustrated in FIG. 9.

The reflection coefficient

$$Γ = \frac{{E}_{R 1}}{{E}_{1}} = \frac{{Z}_{2} - {Z}_{1}}{{Z}_{2} + {Z}_{1}} = \frac{\sqrt{{ɛ}_{1}} - \sqrt{{ɛ}_{2}}}{\sqrt{{ɛ}_{1}} + \sqrt{{ɛ}_{2}}}$$

of the boundary results in an additional transmission path loss of 6.7 dB. The magnitude of the reflected signal traveling back to, but just below the surface coal-air interface is −13.1 dBm. This signal is again partially reflected back into the coal layer. The signal transmission loss through the ATB is an additional 6.4 dB. The total round trip transmission path loss sums to 19.5 dB. The boundary reflected signal S/cluttering geologic noise ratio retuning back to GPRg RMPA is 0.104 or −19.5 dB. The illuminating E_{I}-field must be suppressed by at least 19.5+13=31.5 dB for reliable detection.

The DSB GPRg RMPA receives two different phase coherent reflected double sideband (DSB) waveform signals from the cluttering geology ATB cluttering geologic noise caused by varying moisture, type of boundary rock and fragmentation of the boundary rocks. The early arrival time (EAT) cluttering geologic noise from the ATB interface has an average magnitude of −6.6 dBm. The detection problem now becomes evident. The magnitude of the late arrival time (LAT) reflected DSB signal (S) from the floor boundary interface is a factor of 5.5 times less than the early arrival time DSB signal reflected cluttering geologic noise from the ATB interface.

There is a significant difference in round trip travel time (t) between the early arrival time cluttering geologic noise and the late arrival time DSB signal (S) reflected from the boundary interface. The EM wave velocity (v) in the coal layer is C (i.e., 3×108 m/s) divided by the square root of the relative dialectic constant of coal) and slows down to 1.09×10 8 m/s. When the cutting edges are 609 mm (1′) from the boundary interface, the round trip travel time (t_{TOSB}) is 5.6 nanoseconds. The ERT DSB signal round trip travel time (t_{ATB}) is less than 0.05 nanosecond.

To make the detection problem more difficult, the DSB GPRg transmission and receiving paths are not totally isolated from each other. When a single RMPA sensor is used in the DSB GPRg design, transmitting and receiving functions require an integrated directional coupler (DC). The DC has a directivity specification that seldom exceeds −30 dB. The magnitude of early arrival time coupler transmit path leakage DSB signals is −30 dBm in the receiver channel.

Detection requires revolutionary “cutting edge” spatial (i.e., thin layer) cluttering geology reflection elimination signal processing and phase coherent quadrature detection electronics with imbedded software. Simply stated, revolutionary and evolutionary advancement in radio geophysics technology describes our scientific mission.

Although the present invention has been described in terms of the presently preferred embodiments, it is to be understood that the disclosure is not to be interpreted as limiting. Various alterations and modifications will no doubt become apparent to those skilled in the art after having read the above disclosure. Accordingly, it is intended that the appended claims be interpreted as covering all alterations and modifications as fall within the “true” spirit and scope of the invention.

What is claimed is:

1. A method of operating coal mine machinery that protects and maintains machine operators' health and well-being, comprising:
removing coal mine machine operators from unlimited noise and float coal dust exposures alongside a coal mining machine to inside a less noisy and relatively float coal dust-free environment inside a nearby refuge chamber;
video imaging the view ahead of the coal mining machine with a camera mounted to it and providing a video link to a user display inside the refuge chamber;
engaging the coal mining machine operators in an immersive experience and virtual reality video display on a horizontally projected concave three-dimensional (3D) vision dome;
preventing mining-out-of-seam by displaying to the coal mine machine operators a computer generated graphic and informational display included in the user display of a boundary-layer coal thickness computation derived from a ground penetrating radar measurement provided by a resonant microstrip patch antenna (RMPA) attached to a coal cutting drum of the coal mining machine;
stabilizing the boundary-layer coal thickness computation by mechanically packing loose coal just cut in front of the RMPA with a mechanically adjustable incline ramp attached to the coal cutting drum; and
reproducing the sounds and vibrations present at the coal mining machine inside the refuge chamber for the coal mine machine operators to hear and feel with audio transducers that limit sound levels to predetermined safe limits, and that add to the immersive experience and virtual reality video display on the three-dimensional (3D) vision dome.

2. The method of claim 1, further comprising:
increasing a feeling of virtual reality immersion for the coal mine machine operators by projecting both floor and ceiling displays in the user display that include computer generated image (CGI) animation of coal seam tilting ahead as estimated from boundary-layer coal thickness computations derived from the ground penetrating radar measurements of the RMPA.

3. The method of claim 1, further comprising:
controlling the coal mining machine according to the video, audio, and vibrations reproduced for the coal mine machine operators, with joystick controllers and machine servos.

4. A method of protecting the health and well-being of coal mine machine operators, comprising:
relocating a machine operator's working position to a dust-free quieter environment inside a refuge chamber nearby a coal mining machine;
showing a machine operator in the working position a video of the real environment confronting the coal mining machine and a front mounted camera;
showing the machine operator an augmented reality confronting the coal mining machine using computer generated imagery (CGI) animation derived from the floor and ceiling boundary rock measurements provided by a ground penetrating radar with a resonant microstrip patch antenna (RMPA) mounted in a cutting drum of the coal mining machine;
surrounding the machine operator with reproductions of the sound environment of the coal mining machine with sound transducers;
simulating vibrations in the coal mining machine for the machine operator to feel in a joystick controller; and
controlling the operation of the coal mining machine through the joystick controller to machine control servos in the coal mining machine.

5. The method of claim 4, further comprising:
immersing the machine operator in the working position with video projecting into a hemispherical user display.
